(19) United States
(12) Patent Application Publication
(10) Pub. No.: US 2019/0164239 A1
(43) Pub. Date: May 30, 2019

(54) METHOD AND DEVICE FOR QUERY PROCESSING AND DETERMINING A FUTURE NUMERICAL VALUE OF A SELECTED PRODUCT

(71) Applicant: Amadeus S.A.S., Biot (FR)

(72) Inventors: Michel Demazeau, Nice (FR); Céline Soubra, Antibes (FR); Jean-Philippe Perret, Saint Jeannet (FR); Marco Salibba, Nice (FR); Jacques Bonaud, Cagnes sur Mer (FR)

(21) Appl. No.: 16/183,183

(22) Filed: Nov. 7, 2018

(30) Foreign Application Priority Data
Nov. 30, 2017 (FR) 1761466

(51) Int. Cl. G06Q 50/14; G06F 17/30; G06Q 10/02; G06Q 30/06

(52) U.S. Cl. CPC G06Q 50/14; G06Q 30/0627; G06Q 10/02; G06F 17/30867

(57) ABSTRACT

A query processing device implemented in a server device, the query identifying query parameters and being received from a client device, the query being processed by the server device at the query date, the server device being configured to determine a set of candidate products meeting at least some of the parameters of said query, each candidate product being associated with a current numerical value defined by the current value of the candidate product at the query date, and to transmit to the client device at least a proportion of the candidate products and the respective current numerical value thereof. The query processing device furthermore comprises a processing unit configured to determine at least one future numerical value of the selected candidate product which is equal to an estimate of the current numerical value of the candidate product at a date subsequent to the query date.

### FIELD OF THE INVENTION

The invention relates in general to client/server architectures and in particular to a method and device for query processing and determining a future numerical value of a selected product.

### BACKGROUND

In a product supply server device based on a client/server architecture, a user can submit a query from a client device (user device) to a server device via a communication network to obtain a product. The query comprises a set of query parameters which may be mandatory or optional. The server device can then process the query to determine a set of candidate products best meeting at least some of the query parameters, each candidate product having a numerical value which represents the price of the product. Certain product supply systems may provide products associated with a product date, such as for example a travel supply system which provides candidate products such as air tickets, the value of the product then being the value of the ticket at the time of processing of the query by the server device. A travel query received by such a travel supply system generally comprises an origin, a destination and a travel date.

In one example of application to the travel industry, the product supply server device may be a system of the GDS (“Global Distribution System”) type which allows users to reserve and purchase candidate products such as air or rail tickets or alternatively overnight hotel stays by directly accessing the data provided by the travel supplier (which may be, for example, an airline company in the case of reserving an air ticket).

The computerized product supply systems may make use of optimization algorithms as a function of various data (the optimization algorithms are alternatively known as “revenue management” algorithms). As a consequence, the ticket price may vary over time, i.e. increase or decrease between the date of query processing and the actual travel date.

A user is generally aware that, for a given origin and destination, the ticket price may differ depending on the travel date. A user who, having identified a candidate product following a first query, may for various reasons wish to wait as long as possible before taking an air ticket at a given price or may more generally know when to purchase a billet at the best price. Thus, following a first query which offers a candidate product meeting his/her query, a user does not know if the displayed price will remain the same or if it will imminently rise or fall and, if so, by how much. For example, if a user wants to obtain a ticket for Paris CDG—New York JFK departing on 1 Aug. 2017 and returning on 15 Aug. 2017, he/she may see the ticket at €400 on 1^{st} March, €420 on 1^{st} April before it rises sharply to €900 from 15^{th} April onwards.

A user may attempt to consult statistical data or use his/her own experience of previous purchases in order to optimize the purchase price for his/her ticket. A user may thus realize, before purchasing his/her ticket, that he/she is likely to pay more for the ticket if the departure date is in summer, early October or late December, rather than the rest of the year. In contrast, a user has less control over the stability of a price stated for a given origin, destination and date with one and the same company. He/she also has no information about the time(s) of year when the ticket price is at its lowest. This is because the price may vary over time in line with the “revenue management” policy applied by the airline company. A user is therefore most often obliged to monitor regularly any trends in ticket price before finalizing his/her purchase. It thus often happens that users consult the ticket price they are interested in very many times from their client devices, each time sending a new user query to the server device (travel supply system), and it is possible for the frequency of sending such queries by the user to increase greatly at certain times, in particular when a user has a target date for completing his/her purchase. A user may thus make the same query on several different dates spread over a varying number of days, or even several times per day, to check that the ticket has not gone up since the last query. Each of these is a new query which involves thousands of additional transactions over and above the initial query which has already been carried out at an earlier date. Such queries consume huge volumes of resources at the server device (travel supply system) end, the execution of each query by the server device having in itself a very high computational cost.

There is therefore a need for an improved method and device for query processing capable of optimizing server device resources.

### SUMMARY

The invention relates for this purpose to a query processing device implemented in a server device, the query identifying query parameters and being received from a client device connected to said server device, the query being processed by the server device at a given date denoted query date, the server device being configured to determine a set of candidate products meeting at least some of the parameters of said query, each candidate product being associated with a current numerical value defined by the current value of the candidate product at the query date, and to transmit to the client device at least a proportion of the candidate products and the respective current numerical value thereof, the query processing device furthermore comprising a processing unit configured to determine at least one future numerical value of the selected candidate product which is equal to an estimate of the current numerical value of the candidate product at a date subsequent to the query date, and to transmit to the client device said at least one future numerical value.

Advantageously, the selected candidate product may be associated with at least one reservation class, the query processing device being configured to carry out a class closure step consisting in assigning to the future numerical value the current numerical value of the available reservation class which is the closest to the current numerical value of the reservation class of the selected candidate product.

In one embodiment, the reservation class of the selected product may be obtained in the form of a two-character availability code supplied by an availability server of the server device, the class closure step comprising reinitialization of said two-character availability code.

The query processing device may furthermore comprise an interpretation unit configured to determine, for the selected candidate product, whether a restrictive duration condition applies, the query processing device being configured, in the event of said restrictive duration condition applying, to determine a modified query date by assigning to the future numerical value the current numerical value of the same selected candidate product to which the restrictive duration condition does not apply.

Advantageously, the query processing device may furthermore be configured to hold the query date in the event of the restrictive duration condition not applying.

In particular, the modified query date New time stamp may be determined by the following formula:

New_time_stamp=travel_date−duration_ADVP+1,

in which travel_date corresponds to the product date and duration_ADVP corresponds to the duration preceding the product date during which the restrictive duration condition applies.

Advantageously, the future numerical value may be determined on the basis of a probability factor, determined as a function of at least one of the parameters from a group comprising the query date, the product date, the duration preceding the product date during which the restrictive duration condition applies, and observed class closure speed values.

The invention also relates to a method for processing a query received from a client device in a server device connected to the client device, the query identifying query parameters and the method comprising the steps consisting in:
determining a set of candidate products meeting at least some of the parameters of said query, each candidate product being associated with a current numerical value defined by the current value of the candidate product at the query date,
transmitting to the client device at least a proportion of the candidate products and the respective current numerical value thereof,
the method furthermore comprises the steps consisting in:
selecting one of the candidate products transmitted to the client device,
determining at least one future numerical value of the selected candidate product which is equal to an estimate of the current numerical value of the candidate product at a date subsequent to the query date,
transmitting to the client device said at least one future numerical value.

In one embodiment, the selected candidate product may be associated with at least one reservation class, the method comprising a class closure step consisting in assigning to the future numerical value the current numerical value of the available reservation class which is the closest to the current numerical value of the reservation class of the selected candidate product.

Advantageously, the reservation class of the selected product may be obtained in the form of a two-character availability code supplied by an availability server of the server device, the class closure step comprising reinitialization of said two-character availability code.

In one embodiment, the method may furthermore comprise:
a step of determining, for the selected candidate product, the application of a restrictive duration condition, and
in the event of said restrictive duration condition applying, a step consisting in determining a modified query date by assigning to the future numerical value the current numerical value of the same selected candidate product to which the restrictive duration condition does not apply,
in the event of said restrictive duration condition not applying, a step consisting in holding the query date.

Advantageously, the modified query date New time stamp may be determined by the following formula:

New_time_stamp=travel_date−duration_ADVP+1,

in which travel_date corresponds to the product date and duration_ADVP corresponds to the duration preceding the product date during which the restrictive duration condition applies.

The future numerical value may be determined on the basis of a probability factor, determined as a function of at least one of the parameters from a group comprising the query date, the product date, the duration preceding the product date during which the restrictive duration condition applies, and observed class closure speed values.

Advantageously, a display of the future numerical value associated with the product may be generated on a graphical user interface of a website and/or of a dedicated application.

The invention also relates to a computer program product for processing a query, the computer program product comprising a durable, computer-readable data storage medium and program code saved on the durable, computer-readable storage medium which, when executed by one or more processors, causes the one or more processors to execute the steps of the above-stated method.

### BRIEF DESCRIPTION OF THE DRAWINGS

Other features, details and advantages of the invention will be apparent from reading the description made with reference to the appended drawings provided by way of example in which respectively:

FIG. 1 schematically illustrates the interactions between a client device and a server device;

FIG. 2 schematically illustrates the composition of the client device and the server device;

FIG. 3 schematically illustrates the architecture of the server device according to the invention;

FIG. 4 illustrates a sequence diagram of the query processing method according to the invention;

FIG. 5 schematically illustrates the interactions between a client device and a server device according to the invention;

FIG. 6 illustrates in detail the step of determining the future numerical value.

### DETAILED DESCRIPTION

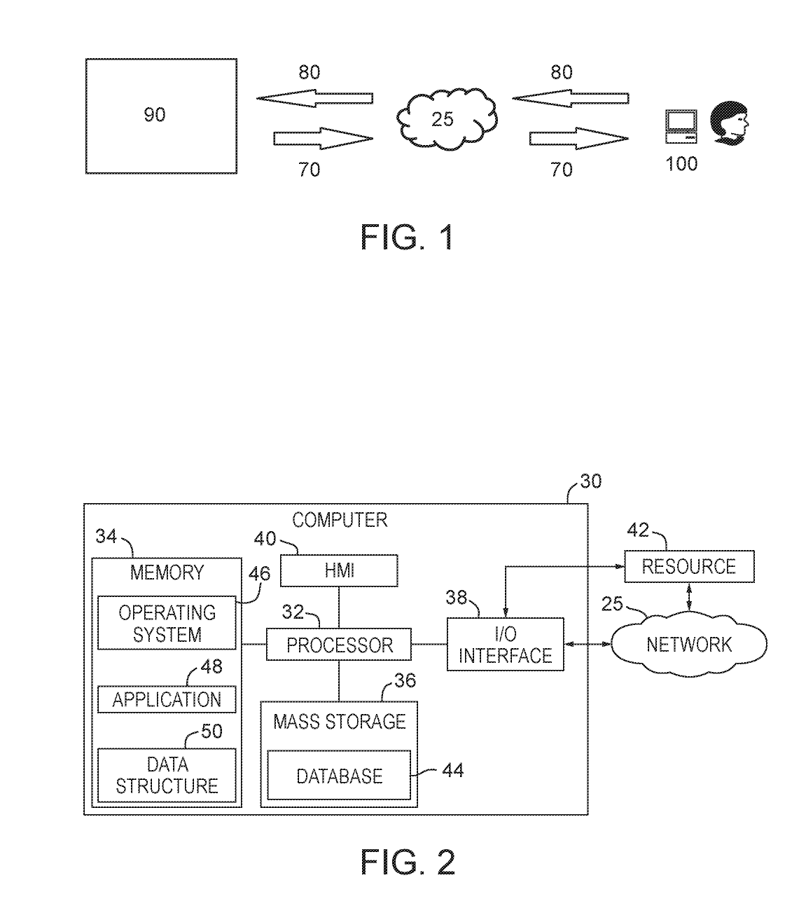

FIG. 1 schematically shows the interactions between a client device and a server device. At least one client device 100 and a server device 90 are connected via a communication network. FIG. 1 shows just one client device 100. However, alternatively and in known manner, the environment may comprise a plurality of client devices 100. The client device 100 may be associated with a plurality of travel agency systems sending service queries via respective client interfaces. Each travel management system may furthermore be connected to different types of client devices submitting different types of requests (or queries) in accordance with a client/server approach, such as user (traveler) devices via respective user interfaces. Each travel management system may also be connected to one or more travel supply systems. In a preferred application of the invention to the travel industry, when a user wishes to reserve an air ticket for example, he/she can submit a query 80 from a user device (for example a computer, tablet or telephone) equipped with an input terminal and display device 100 via a dedicated graphical user interface by specifying an origin, a destination and a departure date. The query 80 is then transmitted to the server device 90 via a communication network 25. The network 25 may include portions of one or more private or public networks (e.g. internet, a virtual private network, a local area network, a wide area network, a cellular telephone network, etc.) which provide interconnection and facilitate the exchange of data containing information. In response to the query, the server device 90 then calculates a list of candidate products 70 which comprises the various available travel options meeting the query, each option being associated with a price representing the price of the travel option. The server device 90 then returns the travel options to the user via the dedicated user interface. The server device 90 is thus capable of returning the list 70 of calculated travel options some time after input of the query 80 via the communication network 25. In current travel supply systems based on client/server architectures, it is desirable for the delay between input of the query and return of the results to be as short as possible in order to optimize user experience.

The server device 90 and/or client devices 100 may be implemented on one or more computers, such as the computer 30, as shown in FIG. 2. The computer 30 may comprise a processor 32, a memory 34, a mass storage memory device 36, an input/output interface (I/O) 38 and a Human-Machine Interface (HMI) 40. The computer 30 may also be functionally linked to one or more external resources 42 via the network 25 and/or an I/O interface 38. External resources may include, but without being limited thereto, servers, databases, mass storage devices, peripheral devices, cloud-based network services, or any other appropriate data-processing resource which may be used by the computer 30. The processor 32 may include one or more devices selected from microprocessors, microcontrollers, digital signal processors, microcomputers, central processing units, field-programmable gate arrays, programmable logic devices, state machines, logic circuits, analog circuits, digital circuits, or other (analog or digital) signal-handling devices depending on the operating instructions which are stored in the memory 34. The memory 34 may include a single memory device or a plurality of memory devices including, but without being limited thereto, a read-only memory (ROM), a random-access memory (RAM), a volatile memory, a non-volatile memory, a static random-access memory (SRAM), a dynamic random-access memory (DRAM), a flash memory, a cache memory, or any other device capable of storing information. The mass storage memory device 36 may include data storage devices such as a hard disk, an optical disk, a cassette drive, a non-volatile semiconductor device, or any other device capable of storing information. A database 44 may reside on the mass storage memory device 36 and may be used to collect and organize data used by the various systems and modules described here. The processor 32 may function under the control of an operating system 46 which resides in the memory 34. The operating system 46 is capable of managing data-processing resources in such a manner that computer program code integrated in the form of one or more software applications, such as an application 48 resident in the memory 34, may have instructions executed by the processor 32. In another embodiment, the processor 32 may execute the application 48 directly, in which case the operating system 46 may be omitted. One or more data structures 50 may also reside in the memory 34 and may be used by the processor 32, the operating system 46 and/or the application 48 for storing or handling data. The I/O interface 38 may provide a machine interface which functionally links the processor 32 to other devices and systems, such as the network 25 and/or an external resource 42. The application 48 may thus cooperate with the network 25 and/or an external resource 42 by communicating via the I/O interface 38 to provide the various distinctive features, functions, applications, processes and/or modules comprising embodiments of the invention. The application 48 may also have program code which is executed by one or more external resources 42, or otherwise rely on functions and/or signals supplied by other system or network components external to the computer 30. Given the almost infinite number of possible hardware and software configurations, a person skilled in the art will understand that the embodiments of the invention may include applications which are located externally to the computer 30, distributed on a number of computers or other external resources 42, or provided by data-processing resources (hardware or software) in the form of a network 25 service, such as a cloud computing service. The HMI interface 40 may be functionally linked to the processor 32 of the computer 30 in known manner to allow a user of the computer 30 to interact directly with the computer 30. The HMI interface 40 may include video and/or alphanumeric screens, a touch screen, a loudspeaker and any other appropriate audio and visual indicator capable of providing information to the user. The HMI interface 40 may also include input devices and controls such as an alphanumeric keypad, a pointing device, numeric keypads, pushbuttons, control buttons, microphones, etc., capable of receiving commands and input data originating from the user and to transmit the inputs made to the processor 32.

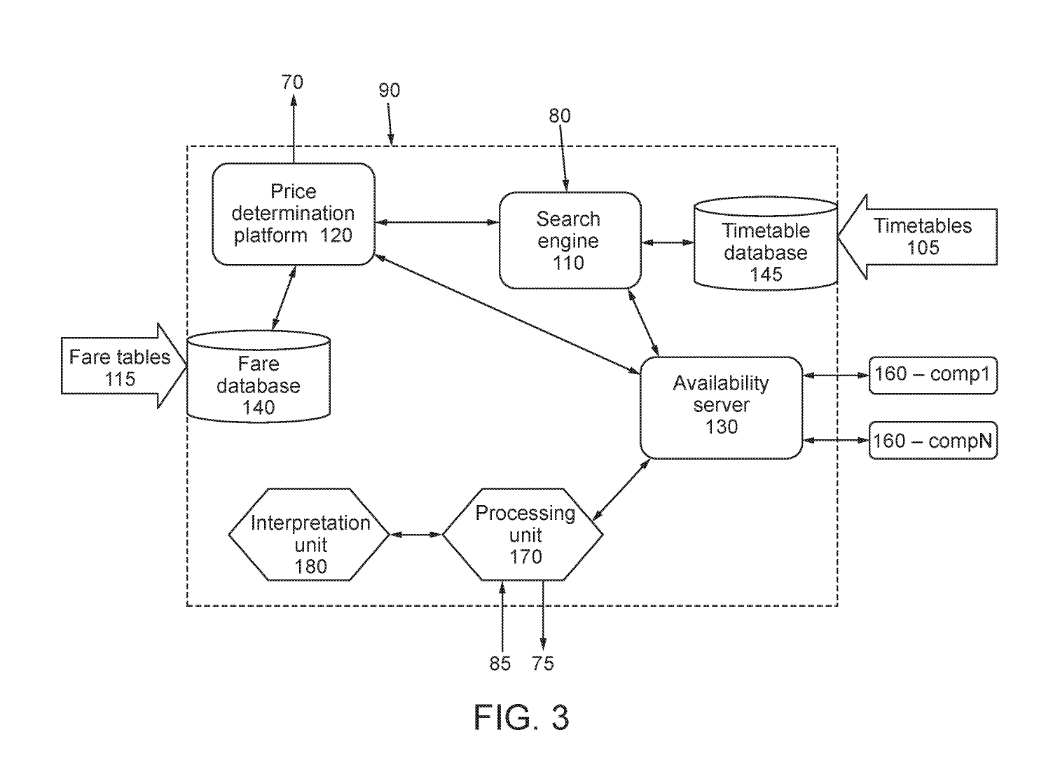

FIG. 3 illustrates a detailed schematic view of the server device 90, in an example of application of the invention to the field of the travel industry, according to certain embodiments. The server device 90 may be for example a system of the GDS type. The query 80 may be transmitted by client device 100 via the network 25 to the server device 90. The server device 90 may comprise a search engine 110 (also referred to as “trip server” or “travel planner”). The search engine 110 is configured to determine candidate products meeting the query parameters, comprising the date, origin and destination specified by the user. The search engine 110 may proceed in two steps in order to determine travel options. In a first step, the search engine 110 may determine routes or geographic itineraries meeting the query parameters 80. The search engine 110 generally determines a large number of routes taking account of the set of possible connections between the origin and the destination, among the thousands of possible nodes (e.g. commercial airports) in the geographic zone in question. The search engine 110 may furthermore sort and filter such a set of connections throughout the process as a function of a list of criteria. The search engine 110 may also apply a multiplier coefficient to the distance between the origin and destination nodes and screen out any routes (with stopover) which entail traveling a distance greater than that obtained by multiplying the distance between the origin and destination nodes by the multiplier coefficient. In a second step, the search engine 110 may use the routes selected as being the most relevant to create candidate products corresponding to these routes. The search engine may in particular consult the schedules of the candidate products in a timetable database 145. The data present in the timetable database 145 may be imported from a timetable 105 which may be used in centralized manner by a plurality of data-processing systems and updated at a given frequency (e.g. once weekly or once daily). The timetable database 145 may comprise the departure and arrival times together with the corresponding nodes (e.g. airport of the majority of commercial airline companies). On the basis of these data, the search engine 110 may explore the itineraries from origin to destination which are sorted and selected on the basis of a list of criteria over these legs of the itineraries (e.g. sufficient time to make a stopover). The search engine 110 may then determine the various possible candidate products in the form a shortlist of candidate products.

A list comprising a number of candidate products may then be transmitted to an availability server 130. The availability server may be configured to check the availability of the candidate products transmitted to it. The availability server 130 may furthermore be configured to check, for each of the candidate products selected in the different reservation classes and supplied by the search engine 110, whether seats are still available. The availability server 130 may check availability with the inventory systems 160 of airline companies comp1, comp2, comp3, comp4, compN in various ways. For certain companies, the availability server 130 may be designed to dynamically interrogate the inventory system 160 of the airline company regarding the availability of space on a flight for a given class (option known as “polling” or “seamless availability”). Other company inventory systems 160 may send status information (option known as “AVS”, the acronym for “Availability Status”) when the inventory system 160 deems it necessary, for example each time that availability changes. The inventory system 160 belonging to each company may be a data-processing system which stores perishable units or articles of an inventory. In a preferred application of the invention to the travel industry, the inventory system may store units or articles representing seats for multiple flight/date combinations of an airline network, together with cabins and/or reservation classes for each of these flights/dates. For each flight, the inventory system 160 may transmit an inventory result, namely the number of seats available by class, to the availability server 130 in the form of a two-character availability code. The two-character availability code comprises an item of information with two juxtaposed characters, one of the characters taking the form of a letter designating the class, and the other character taking the form of a digit designating the number of seats still available in said class. For example, the inventory system 160 may transmit two-character availability code “B8” if eight seats still remain in class B (possibly belonging, for example, to the “first class” reservation class group) or two-character availability code “J0” if no seats any longer remain in class J (possibly belonging, for example, to the “economy class” reservation class group). The availability server 130 thus relates each product, determined by the search engine 110, to availability in each of the classes in order to construct different travel products. In order to facilitate the description of certain embodiments, the invention will be described with reference to such an application of the invention to the travel sector in which the inventory system 160 is configured for storing seats, by way of non-limiting example.

The candidate products obtained in this way may be transmitted to a price determination platform 120. The number of candidate products transmitted to the price determination platform 120 may be configured and set to a predetermined number. The price determination platform 120 may be configured to determine a price for each of the candidate products transmitted by the availability server 130. The server device 90 may comprise a fare database 140 configured to import prices from a fare table 115 supplied centrally to one or more different existing data-processing systems. For a given trip, defined by an origin and a destination, there may be different applicable fares, each fare being associated with one of the reservation classes available within one and the same flight. As used here, the expression “reservation class” makes reference to an identifier associated with a type of service associated with a flight such as a service available on board a flight, or ticket modification conditions. The reservation classes may be combined into reservation class groups visible by the user for example by the wording “first class”, “business class”, “economy class” or indeed “premium economy class”. Only the price corresponding to the least expensive class of the class group may be transmitted to the user.

The list 70 of candidate products is finally supplied to the user via the input and display terminal 100. Thus, for each query carried out by a user, there are conventionally thousands of transactions which are carried out by the server device 90. The search engine 110 receives a very high volume of traffic and has to respond quickly and in optimized manner. Such a search engine is generally subject to very stringent requirements in terms of performance and response time. Furthermore, the price determination platform 120 conventionally consumes very large amounts of data-processing resources and in particular of CPU resources. Such consumption is in particular due to the calculation of fare combinations carried out as a function of the countries of travel, the number of stopovers for each ticket offered, and more generally of the complexity of the itinerary.

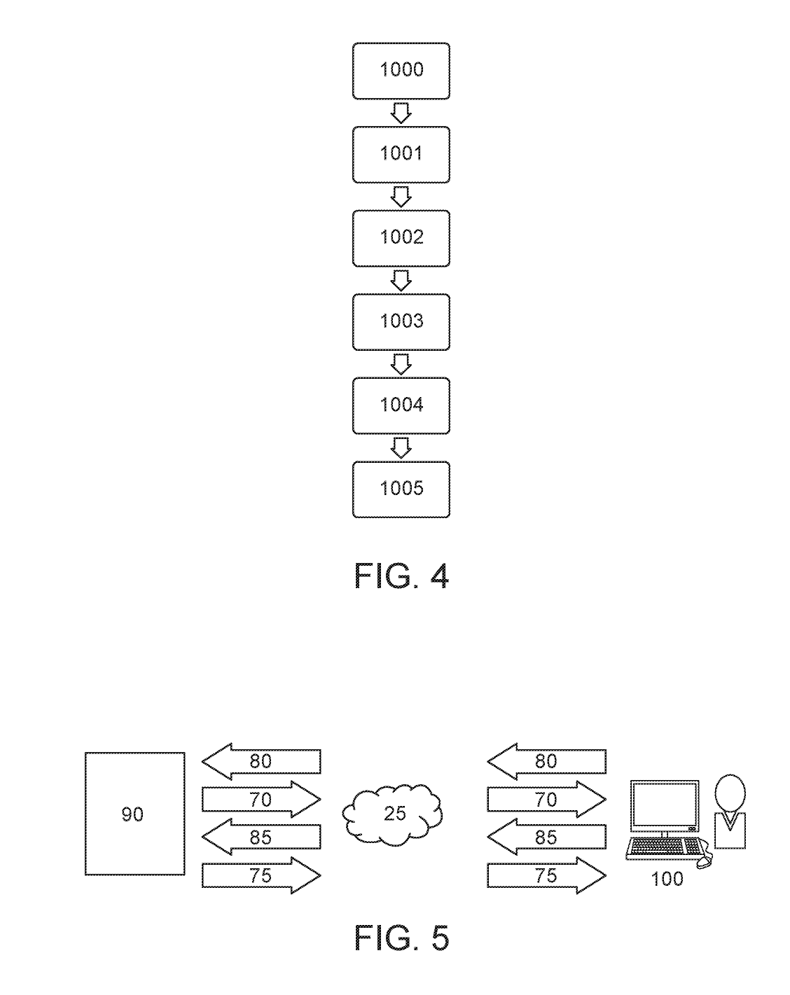

FIG. 4 illustrates the various steps of the method according to the invention. FIG. 5 illustrates the various interactions between the user and the server 90, in accordance with certain embodiments. In a first step 1000, the user inputs a query 80 comprising certain criteria, for example an origin, a destination and at least one travel date. In step 1001, candidate products 70 best meeting the search criteria are determined and then transmitted to the user in step 1002 with their current numerical value. A candidate product, for which the user may wish to know the future numerical value in the case of an upcoming modification, may be selected by the user in a second query 85, during step 1003. The future numerical value 75 is determined in step 1004 for said selected candidate product and then transmitted to the user in step 1005.

The future numerical value, determined in step 1004, may be calculated in various ways. One of the candidate products, among those transmitted to the client device 100, may be selected by the user in order to obtain an estimate of a future numerical value of the candidate product. The future numerical value corresponds to the numerical value of the candidate product at a date subsequent to the query date. In an example of application of the invention to the field of the travel industry, the future numerical value may correspond to an estimate of the ticket price at a future date. For a particular ticket, the ticket price may be modified a number of times at different dates or moments in time. The method and device according to the invention thus make it possible to determine what the next ticket price will be in the case of an upcoming modification thereof and so provide the user with additional information.

The candidate products may in particular be selected by the user when the user's pointer is held at least for a predetermined duration at a graphical location denoting one of the candidate products. The candidate products may also be selected by pressing a dedicated button on the graphical user interface. The second query 85 sent by the user, and corresponding to the selected candidate product, may be transmitted to a processing unit 170. The query may comprise the travel plan selected by the user, for example the origin, destination, travel dates, flight numbers and company codes. It may also comprise details about the selected travel plan, such as for example the ticket price and its fare structure, namely the classes of the various tickets. The processing unit 170 may host a REST API (Representational State Transfer Application Programming Interface) order to implement certain steps of the method according to the invention.

According to a first embodiment, the response from the availability server 130 comprising the inventory result may be retrieved by the processing unit 170. The inventory result may comprise the two-character availability code comprising the number of products available in a given class. The two-character availability code may be reinitialized by the processing unit 170, so as to assign the value “0” to the character designating the remaining number of seats, so triggering a “class closure” procedure. In this manner, the processing unit 170 can simulate product unavailability for the class of the selected candidate product. The two-character availability code is then transmitted to the availability server 130 and the recalculated product value, taking account of the class closure, is determined by the price determination platform 120. In the event of the product comprising a number of legs, for example in the event of a stopover in field of the travel industry, there may be a number of classes for which closure is to be simulated.

The processing unit 170 may then trigger closure of the class according to all the possible combinations, so creating one or more similar products. A product is said to be “similar” to a given product if it has a product date having the same day of the month and same month as the given product, together with the same legs and identical services.

The processing unit 170 may then analyze the various resultant products to deduce which one has the greatest probability of occurring by observing the number of seats available by class of service together with the observed speed of sale for said class.

The product/price/probability triplets will be submitted to a “calling” application which will decide the future numerical value 75 to be transmitted to the user.

The future numerical value 75 may then be assigned to the current numerical value of the available reservation class which is the closest to the current numerical value of the reservation class of the selected candidate product.

The future numerical value is thus determined by the price determination platform, taking account of closure of the current class, and then transmitted to the user at the same time as the current value of the selected candidate product. The future numerical value 75 associated with the product may likewise be generated on a graphical user interface of a website and/or of a dedicated application. Such an embodiment thus avoids the user carrying out a future new query, identical to his/her initial query, so optimizing the data-processing resources of the servers.

According to a second embodiment, the future numerical value may be determined by extracting an item of timestamp information present in the product applicability conditions. The interpretation unit 180 may be configured to extract, from the product applicability conditions, the information relating to the restrictive duration condition of the candidate product selected by the user in the second query 85. Selection by the user of one of the candidate products transmitted in the list 70 generates a second query 85 which is transmitted to the processing unit 170. In one exemplary embodiment of the invention applied to the travel industry, the restrictive duration condition corresponds to a reduction in ticket price, if the ticket is purchased sufficiently prior to the trip, for example, but not exclusively, forty five days prior to departure. In general, if the restrictive duration condition applies to the product, a reduction in the current value may be applied. The product date (travel_date) and the duration preceding the product date during which the restrictive duration condition applies (duration_ADVP) may be obtained by the processing unit 170 sending a query to the availability server 130. The modified query date (New_time_stamp) may be determined by the processing unit 170 in accordance with the following formula:

New_time_stamp=travel_date−duration_ADVP+1

The future numerical value 75 may thus be determined by the price determination platform 120, with the modified query date for which the restrictive duration condition does not apply and then transmitted to the user at the same time as the current value of the selected candidate product. The future numerical value associated with the product may likewise be generated on a graphical user interface of a website and/or of a dedicated application.

Such an embodiment also makes it possible to optimize the data-processing resources of the servers by transmitting items of information to the user to assist with making a decision about the trend in the value of the travel product.

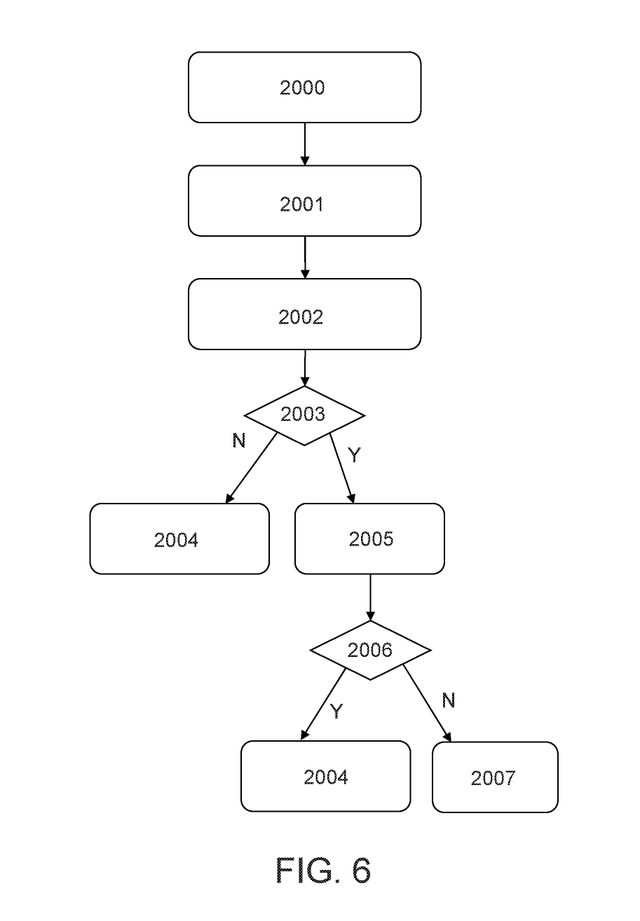

FIG. 6 is a flow chart which describes the method for choosing one or other of the embodiments. In step 2000, the class of the selected product is determined by the processing unit 170. In step 2001, the estimated duration prior to class closure is calculated (d_close_class). This duration may be calculated on the basis of observed speeds of closure of the class of the selected product for identical products. In step 2002, the interpretation unit 180 extracts the information relating to the restrictive duration condition of the selected candidate product. The result of determining the restrictive duration condition is therefore a duration in days. If the restrictive duration condition (2003) does not apply to the selected candidate product, the future numerical value may therefore be determined exclusively via a class closure procedure in step 2004. If the restrictive duration condition (2003) does apply to the selected candidate product, the processing unit 170 determines, in step 2005, the duration which remains until the restrictive duration condition no longer applies (d_break_ADVP). In an exemplary embodiment of the invention applied to the travel industry, if the candidate product may be selected sixty days prior to the trip, and the restrictive duration condition applies at more than forty-five days, the duration which remains until the restrictive duration condition no longer applies is equal to fifteen days. The estimated duration prior to class closure is compared (2006) with the duration which remains until the restrictive duration condition no longer applies. If the estimated duration prior to class closure (d_close_class) is less than the duration which remains until the restrictive duration condition no longer applies (d break ADVP), the future numerical value is therefore determined exclusively via a class closure procedure in step 2004. Conversely, the future numerical value is therefore determined exclusively by modifying the query date such that the future numerical value is equal to the current numerical value of the same selected candidate product without application of the restrictive duration condition (step 2007). Selecting one or other of the embodiments thus makes it possible to transmit the most probable future numerical value to the user.

The device and the method provided by the invention thus make it possible to avoid overloading server devices by limiting the number of identical queries from one and the same user. Transmitting additional price trend data to the user thus makes it possible substantially to reduce the response time of the server devices and to increase the performance of the server device.

According to one embodiment of the invention, an on-hold value for the candidate product may be transmitted to the user at the same time as the future numerical value, so enabling the user to postpone finalizing the purchase of the candidate product. In one exemplary embodiment of the invention applied to the travel industry, the ticket may be blocked for a predetermined duration (for example twenty four or forty eight hours) if the on-hold option has been selected for the candidate product. He/she may then delay purchase of the ticket by the predetermined duration and is guaranteed to be able to finalize purchase of the desired ticket prior to the end of the predetermined duration. In the airline industry, a charge is generally payable for the on-hold option for the candidate product. The on-hold value, which corresponds to the amount payable by the user to block the candidate product for the offered duration, is generally static, i.e. it does not vary according to contextual criteria linked to the query results. Suggesting to the user an on-hold option for the candidate product which has an on-hold value greater than the difference between the future numerical value and the current numerical value would not encourage the user to select this option. It could be, for example, that a selected product has a current value of EUR500, a future numerical value of EUR550 and an on-hold value of EUR100. From the user's standpoint, there would then be a conflict between the procedure for calculating the future numerical value and the displayed on-hold value which would make the airline company's system, and in particular its calculation of the future numerical value, opaque to the user. The user might then be encouraged to make the same query at another date, which is contrary to the effect desired by the present invention.

A dynamic on-hold option and dynamically determining the on-hold value, instead of a static on-hold value, would make it possible to adjust the on-hold value as a function of the current numerical value and the future numerical value. According to a first embodiment, the on-hold option may be offered if the future numerical value is more than a certain percentage higher than the current numerical value (for example ten per cent). According to a second embodiment, the on-hold option may be offered if the number of seats remaining in the class selected by the user is less than a threshold. According to a third embodiment, the on-hold option may be offered if there is a number of passengers in the user query which exceeds a certain threshold (for example from three passengers upwards). This is because, in the second and third embodiments, the availability constraints applying to the remaining seats may make it advisable to subscribe to the on-hold option. The on-hold option for the candidate product is therefore offered dynamically, depending on the context. The on-hold value for the candidate product may furthermore be determined dynamically. It may, for example, be determined by taking account of the difference between the future numerical value and the current numerical value, of the number of seats still available or of the number of passengers in the user query.

A person skilled in the art will understand that the methods according to the embodiments may be implemented in various manners by hardware, software, or a combination of hardware and software, in particular in the form of program code which can be distributed in the form a program product in various forms. In particular, the program code may be distributed with the assistance of computer-readable media which may include computer-readable storage media and communication media. The methods described in the present description may in particular be implemented in the form computer program instructions executable by one or more processors in a computer data-processing device. These computer program instructions may also be stored on a computer-readable medium.

1-15. (canceled)

16. A query processing device comprising:
a server device, the server device receiving query identifying query parameters from a client device connected to said server device, the query being processed by the server device at a given date denoted query date, the server device being configured to determine a set of candidate products meeting at least some of the parameters of said query, each candidate product being associated with a current numerical value defined by the current value of the candidate product at the query date, and to transmit to the client device at least a proportion of the candidate products and the respective current numerical value thereof,
wherein the query processing device furthermore comprises a processing unit configured to determine at least one future numerical value of the selected candidate product which is equal to an estimate of the current numerical value of the candidate product at a date subsequent to the query date, and to transmit to the client device said at least one future numerical value.

17. The device of claim 16 wherein the selected candidate product is associated with at least one reservation class, the query processing device being configured to carry out a class closure including assigning to the future numerical value the current numerical value of the available reservation class which is the closest to the current numerical value of the reservation class of the selected candidate product.

18. The device of claim 17 wherein the reservation class of the selected product is obtained in the form of a two-character availability code supplied by an availability server of the server device, and the class closure comprises reinitialization of said two-character availability code.

19. The device according of claim 17 wherein the future numerical value is determined on the basis of a probability factor, and the probability factor determined as a function of the query date, the product date, the duration preceding the product date during which the restrictive duration condition applies, observed class closure speed values, or a combination thereof.

20. The device of claim 16 further comprising:
an interpretation unit configured to determine, for the selected candidate product, whether a restrictive duration condition applies, the query processing device being configured, in the event of said restrictive duration condition applying, to determine a modified query date by assigning to the future numerical value the current numerical value of the same selected candidate product to which the restrictive duration condition does not apply.

21. The device of claim 20 wherein the query processing device is further configured to hold the query date in the event of the restrictive duration condition not applying.

22. The device of claim 20 wherein the modified query date (New_time_stamp) is determined by the following formula:
New_time_stamp=travel_date−duration_ADVP+1,
wherein travel_date corresponds to the product date and duration_ADVP corresponds to the duration preceding the product date during which the restrictive duration condition applies.

23. A method for processing a query received from a client device in a server device connected to the client device, the method comprising:
determining a set of candidate products meeting at least some of the parameters of said query, each candidate product being associated with a current numerical value defined by the current value of the candidate product at the query date;
transmitting to the client device at least a proportion of the candidate products and the respective current numerical value thereof;
selecting one of the candidate products transmitted to the client device;
determining at least one future numerical value of the selected candidate product which is equal to an estimate of the current numerical value of the candidate product at a date subsequent to the query date; and
transmitting to the client device said at least one future numerical value.

24. The method of claim 23 wherein the selected candidate product is associated with at least one reservation class, and further comprising:
assigning to the future numerical value the current numerical value of the available reservation class which is the closest to the current numerical value of the reservation class of the selected candidate product to provide a class closure.

25. The method of claim 24 wherein the reservation class of the selected product is obtained in the form of a two-character availability code supplied by an availability server of the server device, and the class closure further comprising reinitialization of said two-character availability code.

26. The method of claim 23 further comprising:
determining, for the selected candidate product, the application of a restrictive duration condition;
in the event of said restrictive duration condition applying, determining a modified query date by assigning to the future numerical value the current numerical value of the same selected candidate product to which the restrictive duration condition does not apply; and
in the event of said restrictive duration condition not applying, holding the query date.

27. The method of claim 26 wherein the modified query date (New_time_stamp) is determined by the following formula:
New_time_stamp=travel_date−duration_ADVP+1,
in which travel_date corresponds to the product date and duration_ADVP corresponds to the duration preceding the product date during which the restrictive duration condition applies.

28. The method of claim 23 wherein the future numerical value is determined on the basis of a probability factor, and the probability factor is determined as a function of the query date, the product date, the duration preceding the product date during which the restrictive duration condition applies, observed class closure speed values, or a combination thereof.

29. The method of claim 23 wherein a display of the future numerical value associated with the product is generated on a graphical user interface of a web site and/or of a dedicated application.

30. A computer program product for processing a query received from a client device in a server device connected to the client device, the computer program product comprising:
a durable, computer-readable data storage medium; and
program code saved on the durable, computer-readable storage medium which, when executed by one or more processors, causes the one or more processors of the server device to execute a method comprising:
determining a set of candidate products meeting at least some of the parameters of said query, each candidate product being associated with a current numerical value defined by the current value of the candidate product at the query date;
transmitting to the client device at least a proportion of the candidate products and the respective current numerical value thereof;
selecting one of the candidate products transmitted to the client device;
determining at least one future numerical value of the selected candidate product which is equal to an estimate of the current numerical value of the candidate product at a date subsequent to the query date; and
transmitting to the client device said at least one future numerical value.
